(19) United States
(12) Patent Application Publication
(10) Pub. No.: US 2026/0098729 A1
(43) Pub. Date: Apr. 9, 2026

(54) METHOD AND SYSTEM FOR CAPTURING A MODIFIED FLIGHT DESCENT PLAN

(71) Applicant: HONEYWELL INTERNATIONAL INC., Charlotte, NC (US)

(72) Inventors: Srihari Jayathirtha, Phoenix, AZ (US); Rajesh Chaubey, Bangalore (IN)

(73) Assignee: HONEYWELL INTERNATIONAL INC., Charlotte, NC (US)

(21) Appl. No.: 19/007,796

(22) Filed: Jan. 2, 2025

(30) Foreign Application Priority Data
Oct. 3, 2024 (IN) 202411074732

(51) Int. Cl. G01C 21/20; B64D 43/00; G01C 21/00

(52) U.S. Cl. CPC G01C 21/20; B64D 43/00; G01C 21/005

(57) ABSTRACT

A method and system is provided for capturing a modified flight descent path for an aircraft has been developed. The method first generates a descent approach path for an aircraft with a flight management system (FMS). A proposed recovery path is generated for the aircraft that rejoins the descent approach path. The proposed recovery path is generated when the aircraft deviates from the descent approach path during flight operations. Inputs for the proposed recovery path for the aircraft are received with the FMS. The inputs are aircraft flight parameters that are received from aircrew members of the aircraft. The proposed recovery path is modified to comply with the inputs from the aircrew members. The modified recovery path is then integrated into the descent approach path with the FMS.

### CROSS REFERENCE TO RELATED APPLICATION

This application claims priority to India Provisional Patent Application No. 202411074732, filed Oct. 3, 2024, the entire content of which is incorporated by reference herein.

### TECHNICAL FIELD

The present invention generally relates to aircraft flight operations, and more particularly relates to a method and system for capturing a modified flight descent plan.

### BACKGROUND

One performance function of a Flight Management System (FMS) computes a Theoretical Descent Path (TDP) which is an optimized path for an aircraft from a cruising flight level to a landing runway. However, the TDP is computed automatically without any aircrew input on aircraft operational parameters which may result in undesirable aircraft performance. Hence, there is a need for a method and system for capturing a modified flight descent plan with flight crew input.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for capturing a modified flight descent path for an aircraft. The method comprises: generating a descent approach path for an aircraft with a flight management system (FMS); deviating from the descent approach path during flight operations; generating a proposed recovery path for the aircraft with the FMS, where the proposed recovery path rejoins the descent approach path; receiving inputs for the proposed recovery path for the aircraft with the FMS, where the inputs comprised aircraft flight parameters that are received from aircrew members of the aircraft; modifying the proposed recovery path to comply with the inputs from the aircrew members; and integrating the modified recovery path into the descent approach path with the FMS.

A system is provided for capturing a modified flight descent path for an aircraft. The system comprises: a flight management system (FMS) that, generates a descent approach path for an aircraft, generates a proposed recovery path for the aircraft that rejoins the descent approach path, where the proposed recovery path is generated when the aircraft deviates from the descent approach path during flight operations, receives inputs for the proposed recovery path from aircrew members of the aircraft, where the inputs comprised aircraft flight parameters that are received from aircrew members of the aircraft, modifies the proposed recovery path to comply with the inputs from the aircrew members, and integrates the modified recovery path into the descent approach path; and a vertical navigation (VNAV) display that shows the modified recovery path to the aircrew members.

Furthermore, other desirable features and characteristics of the disclosed embodiments will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 shows a diagram of an in-flight aircraft that contains an onboard flight management system (FMS) along with a visual data system that is accessed by the FMS in accordance with one embodiment;

FIG. 2 shows a block diagram of a flight management computer system in accordance with one embodiment;

FIG. 3 shows a diagram of a vertical profile view of a captured descent path with modifications in accordance with one embodiment;

FIG. 4 shows a captured descent path on a display system with modifications in accordance with one embodiment; and

FIG. 5 shows a flowchart of a method for capturing a modified flight descent path for an aircraft in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A method and system is provided for capturing a modified flight descent path for an aircraft has been developed. The method first generates a descent approach path for an aircraft with a flight management system (FMS). A proposed recovery path is generated for the aircraft that rejoins the descent approach path. The proposed recovery path is generated when the aircraft deviates from the descent approach path during flight operations. Inputs for the proposed recovery path for the aircraft are received with the FMS. The inputs are aircraft flight parameters that are received from aircrew members of the aircraft. The proposed recovery path is modified to comply with the inputs from the aircrew members. The modified recovery path is then integrated into the descent approach path with the FMS.

Before proceeding further, it is noted that, for convenience, the following description is in the context of an aircraft environment. It will be appreciated, however, that the claimed invention is not limited to any particular aircraft environment, but may be implemented in numerous other vehicular and non-vehicular environments.

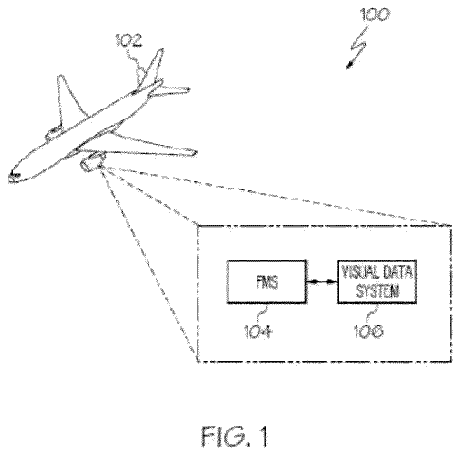

Turning now to FIG. 1, a diagram 100 is shown of an in-flight aircraft 102 that contains an onboard flight management system (FMS) 104 along with a visual data system 106 that is accessed by the FMS 104 in accordance with one embodiment. In alternative embodiments, the visual data system 106 may be integrated as part of the FMS 104. The FMS 104, as is generally known, is a specialized computer that automates a variety of in-flight tasks such as in-flight management of the flight plan. Using various sensors such as global positioning system (GPS), the FMS 104 determines the aircraft's position and guides the aircraft along its flight plan using its navigation database. From the cockpit, the FMS 104 is normally controlled through a visual display device such as a control display unit (CDU) which incorporates a small screen, a keyboard or a touchscreen. The FMS 104 displays the flight plan and other critical flight data to the aircrew during operation.

The FMS 104 may have a built-in electronic memory system that contains a navigation database. The navigation database contains elements used for constructing a flight plan. In some embodiments, the navigation database may be separate from the FMS 104 and located onboard the aircraft while in other embodiments the navigation database may be located on the ground and relevant data provided to the FMS 104 via a (non-illustrated) communications link with a (non-illustrated) ground station. The navigation database used by the FMS 104 may typically include: waypoints/intersections; airways; radio navigation aids/navigation beacons; airports; runway; standard instrument departure (SID) information; standard terminal arrival (STAR) information; holding patterns; and instrument approach procedures. Additionally, other waypoints may also be manually defined by pilots along the route.

The flight plan is generally determined on the ground before departure by either the pilot or a dispatcher for the owner of the aircraft. It may be manually entered into the FMS 104 or selected from a library of common routes. In other embodiments the flight plan may be loaded via a communications data link from an airline dispatch center. During preflight planning, additional relevant aircraft performance data may be entered including information such as: gross aircraft weight; fuel weight and the center of gravity of the aircraft. The aircrew may use the FMS 104 to modify the plight flight plan before takeoff or even while in flight for variety of reasons. Such changes may be entered via the CDU. Once in flight, the principal task of the FMS 104 is to accurately monitor the aircraft's position. This may use a GPS, a VHF omnidirectional range (VOR) system, or other similar sensor in order to determine and validate the aircraft's exact position. The FMS 104 constantly cross checks among various sensors to determine the aircraft's position with accuracy.

Additionally, the FMS 104 may be used to perform advanced vertical navigation (VNAV) functions. The purpose of VNAV is to predict and optimize the vertical path of the aircraft. The FMS 104 provides guidance that includes control of the pitch axis and of the throttle of the aircraft. In order to accomplish these tasks, the FMS 104 has detailed flight and engine model data of the aircraft. Using this information, the FMS 104 may build a predicted vertical descent path for the aircraft. A correct and accurate implementation of VNAV has significant advantages in fuel savings and on-time efficiency.

In exemplary embodiments, an existing flight management computer (FMC) (or flight management system (FMS)) onboard an aircraft is utilized to communicate data between existing onboard avionics systems or line-replaceable units (LRUs) and another module coupled to the FMC, which supports or otherwise performs new flight management functionality that is not performed by the FMC. For example, a multifunction control and display unit (MCDU) may support or otherwise perform new flight management functionality based on data from onboard avionics or LRUs received via the FMC. In this regard, the FMC is configured to receive operational or status data from one or more avionics systems or LRUs onboard the aircraft at corresponding avionics interfaces and convert one or more characteristics of the operational data to support communicating the operational data with the MCDU. For purposes of explanation, the subject matter may primarily be described herein in the context of converting operational data received from onboard avionics or LRUs in a first format (e.g., an avionics bus format) into another format supported by the interface with the MCDU, the subject matter described herein is not necessarily limited to format conversions or digital reformatting, and may be implemented in an equivalent manner for converting between other data characteristics, such as, for example, different data rates, throughputs or bandwidths, different sampling rates, different resolutions, different data compression ratios, and the like.

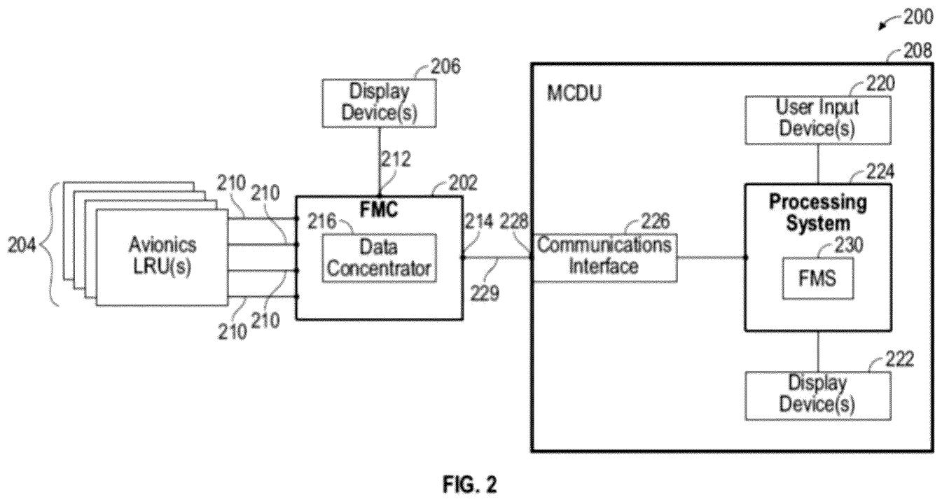

FIG. 2 depicts an exemplary embodiment of an aircraft system 200 suitable for implementation onboard an aircraft 102 shown previously in FIG. 1. The illustrated aircraft system 200 includes a flight management computing module 202 communicatively coupled to a plurality of onboard avionics LRUs 204, one or more display devices 206, and a multifunction computing module 208. It should be appreciated that FIG. 2 depicts a simplified representation of the aircraft system 200 for purposes of explanation, and FIG. 2 is not intended to limit the subject matter in any way.

The flight management computing module 202 generally represents the FMC, the FMS, or other hardware, circuitry, logic, firmware and/or other components installed onboard the aircraft and configured to perform various tasks, functions and/or operations pertaining to flight management, flight planning, flight guidance, flight envelope protection, four-dimensional trajectory generation or required time of arrival (RTA) management, and the like. Accordingly, for purposes of explanation, but without limiting the functionality performed by or supported at the flight management computing module 202, the flight management computing module 202 may alternatively be referred to herein as the FMC. The FMC 202 includes a plurality of interfaces 210 configured to support communications with the avionics LRUs 204 along with one or more display interfaces 212 configured to support coupling one or more display devices 206 to the FMC 202. In the illustrated embodiment, the FMC 202 also includes a communications interface 214 that supports coupling the multifunction computing module 208 to the FMC 202.

The FMC 202 generally includes a processing system designed to perform flight management functions, and potentially other functions pertaining to flight planning, flight guidance, flight envelope protection, and the like. Depending on the embodiment, the processing system could be realized as or otherwise include one or more processors, controllers, application specific integrated circuits, programmable logic devices, discrete gate or transistor logics, discrete hardware components, or any combination thereof. The processing system of the FMC 202 generally includes or otherwise accesses a data storage element (or memory), which may be realized as any sort of non-transitory short or long term storage media capable of storing programming instructions for execution by the processing system of the FMC 202. In exemplary embodiments, the data storage element stores or otherwise maintains code or other computer-executable programming instructions that, when read and executed by the processing system of the FMC 202, cause the FMC 202 to implement, generate, or otherwise support a data concentrator application 216 that performs certain tasks, operations, functions, and processes described herein.

The avionics LRUs 204 generally represent the electronic components or modules installed onboard the aircraft that support navigation, flight planning, and other aircraft control functions in a conventional manner and/or provide real-time data and/or information regarding the operational status of the aircraft to the FMC 202. For example, practical embodiments of the aircraft system 200 will likely include one or more of the following avionics LRUs 204 suitably configured to support operation of the aircraft: a weather system, an air traffic management system, a radar system, a traffic avoidance system, an autopilot system, an autothrottle (or autothrust) system, a flight control system, hydraulics systems, pneumatics systems, environmental systems, electrical systems, engine systems, trim systems, lighting systems, crew alerting systems, electronic checklist systems, and/or another suitable avionics system.

In exemplary embodiments, the avionics interfaces 210 are realized as different ports, terminals, channels, connectors, or the like associated with the FMC 202 that are connected to different avionics LRUs 204 via different wiring, cabling, buses, or the like. In this regard, the interfaces 210 may be configured to support different communications protocols or different data formats corresponding to the respective type of avionics LRU 204 that is connected to a particular interface 210. For example, the FMC 202 may communicate navigation data from a navigation system via a navigation interface 210 coupled to a data bus supporting the ARINC 424 (or A424) standard, the ARINC 629 (or A629) standard, the ARINC 422 (or A422) standard, or the like. As another example, a datalink system or other communications LRU 204 may utilize an ARINC 619 (or A619) compatible avionics bus interface for communicating datalink communications or other communications data with the FMC 202.

The display device(s) 206 generally represent the electronic displays installed onboard the aircraft in the cockpit, and depending on the embodiment, could be realized as one or more monitors, screens, liquid crystal displays (LCDs), a light emitting diode (LED) displays, or any other suitable electronic display(s) capable of graphically displaying data and/or information provided by the FMC 202 via the display interface(s) 212. Similar to the avionics interfaces 210, the display interfaces 212 are realized as different ports, terminals, channels, connectors, or the like associated with the FMC 202 that are connected to different cockpit displays 206 via corresponding wiring, cabling, buses, or the like. In one or more embodiments, the display interfaces 212 are configured to support communications in accordance with the ARINC 661 (or A661) standard. In one embodiment, the FMC 202 communicates with a lateral map display device 206 using the ARINC 702 (or A702) standard.

In exemplary embodiments, the multifunction computing module 208 is realized as a multifunction control and display unit (MCDU) that includes one or more user interfaces, such as one or more input devices 220 and/or one or more display devices 222 (shown previously as 106 in FIG. 1), a processing system 224, and a communications module 226. The MCDU 208 generally includes at least one user input device 220 that is coupled to the processing system 224 and capable of receiving inputs from a user, such as, for example, a keyboard, a key pad, a mouse, a joystick, a directional pad, a touchscreen, a touch panel, a motion sensor, or any other suitable user input device or combinations thereof. The display device(s) 222 may be realized as any sort of monitor, screen, LCD, LED display, or other suitable electronic display capable of graphically displaying data and/or information under control of the processing system 224.

The processing system 224 generally represents the hardware, circuitry, logic, firmware and/or other components of the MCDU 208 configured to perform the various tasks, operations, functions and/or operations described herein. Depending on the embodiment, the processing system 224 may be implemented or realized with a general purpose processor, a microprocessor, a controller, a microcontroller, a state machine, an application specific integrated circuit, a field programmable gate array, any suitable programmable logic device, discrete gate or transistor logic, discrete hardware components, or any combination thereof, designed to perform the functions described herein. Furthermore, the steps of a method or algorithm described in connection with the embodiments disclosed herein may be embodied directly in hardware, in firmware, in a software module executed by the processing system 224, or in any practical combination thereof. In this regard, the processing system 224 includes or accesses a data storage element (or memory), which may be realized using any sort of non-transitory short or long term storage media, and which is capable of storing code or other programming instructions for execution by the processing system 224. In exemplary embodiments described herein, the code or other computer-executable programming instructions, when read and executed by the processing system 224, cause the processing system 224 to implement with an FMS 230 (shown previously as 104 in FIG. 1) additional tasks, operations, functions, and processes described herein.

The communications module 226 generally represents the hardware, module, circuitry, software, firmware and/or combination thereof that is coupled between the processing system 224 and a communications interface 228 of the MCDU 208 and configured to support communications between the MCDU 208 and the FMC 202 via an electrical connection 229 between the MCDU communications interface 228 and the FMC communications interface 214. For example, in one embodiment, the communications module 226 is realized as an Ethernet card or adapter configured to support communications between the FMC 202 and the MCDU 208 via an Ethernet cable 229 provided between Ethernet ports 214, 228. In other embodiments, the communications module 226 is configured to support communications between the FMC 202 and the MCDU 208 in accordance with the ARINC 429 (A429) standard via an A429 data bus 229 provided between A429 ports 214, 228 of the respective modules 202, 208. In yet other embodiments, the communications module 226 is configured to support communications between the FMC 202 and the MCDU 208 in accordance with the ARINC 422 (A422) standard via an A422 data bus 229 provided between A422 ports 214, 228 of the respective modules 202, 208. In yet other embodiments, the communications module 226 is configured to support communications between the FMC 202 and the MCDU 208 in accordance with the ARINC 739 (A739) standard via an A739 data bus 229 provided between A739 ports 214, 228 of the respective modules 202, 208.

In various embodiments, the FMC 202 and MCDU 208 communicate using a different communications protocol or standard than one or more of the avionics LRUs 204 and/or the display devices 206. In such embodiments, to support communications of data between the MCDU 208 and those LRUs 204 and/or display devices 206, the data concentrator application 216 at the FMC 202 converts data from one format to another before retransmitting or relaying that data to its destination. For example, the data concentrator application 216 may convert data received from an avionics LRU 204 to the A429 or Ethernet format before providing the data to the MCDU 208, and vice versa. Additionally, in exemplary embodiments, the FMC 202 validates the data received from an avionics LRU 204 before transmitting the data to the MCDU 208. For example, the FMC 202 may perform debouncing, filtering, and range checking, and/or the like prior to converting and retransmitting data from an avionics LRU 204.

It should be noted that although the subject matter may be described herein in the context of the multifunction computing module 208 being realized as an MCDU, in alternative embodiments, the multifunction computing module 208 could be realized as an electronic flight bag (EFB) or other mobile or portable electronic device. In such embodiments, an EFB capable of supporting an FMS 230 application may be connected to an onboard FMC 202 using an Ethernet cable 229 to support flight management functionality from the EFB in an equivalent manner as described herein in the context of the MCDU.

In one or more embodiments, the MCDU 208 stores or otherwise maintains programming instructions, code, or other data for programming the FMC 202 and transmits or otherwise provides the programming instructions to the FMC 202 to update or otherwise modify the FMC 202 to implement the data concentrator application 216. For example, in some embodiments, upon establishment of the connection 229 between modules 202, 208, the MCDU 208 may automatically interact with the FMC 202 and transmit or otherwise provide the programming instructions to the FMC 202, which, in turn, executes the instructions to implement the data concentrator application 216. In some embodiments, the data concentrator application 216 may be implemented in lieu of flight management functionality by the MCDU 208 reprogramming the FMC 202. In other embodiments, the FMC 202 may support the data concentrator application 216 in parallel with flight management functions. In this regard, the FMC 202 may perform flight management functions, while the FMS 230 application on the MCDU 208 supplements the flight management functions to provide upgraded flight management functionality within the aircraft system 200.

The FMS, as is generally known, is a specialized computer that automates a variety of in-flight tasks such as in-flight management of the flight plan. Using various sensors such as global positioning system (GPS), the FMS determines the aircraft's position and guides the aircraft along its flight plan using its navigation database. From the cockpit, the FMS is normally controlled through a visual display device such as a control display unit (CDU) which incorporates a small screen, a keyboard or a touchscreen. The FMS displays the flight plan and other critical flight data to the aircrew during operation.

The FMS may have a built-in electronic memory system that contains a navigation database. The navigation database contains elements used for constructing a flight plan. In some embodiments, the navigation database may be separate from the FMS and located onboard the aircraft while in other embodiments the navigation database may be located on the ground and relevant data provided to the FMS via a communications link with a ground station. The navigation database used by the FMS may typically include: waypoints/intersections; airways; radio navigation aids/navigation beacons; airports; runway; standard instrument departure (SID) information; standard terminal arrival (STAR) information; holding patterns; and instrument approach procedures. Additionally, other waypoints may also be manually defined by pilots along the route.

The flight plan is generally determined on the ground before departure by either the pilot or a dispatcher for the owner of the aircraft. It may be manually entered into the FMS or selected from a library of common routes. In other embodiments the flight plan may be loaded via a communications data link from an airline dispatch center. During preflight planning, additional relevant aircraft performance data may be entered including information such as: gross aircraft weight; fuel weight and the center of gravity of the aircraft. The aircrew may use the FMS to modify the plight flight plan before takeoff or even while in flight for variety of reasons. Such changes may be entered via the CDU. Once in flight, the principal task of the FMS is to accurately monitor the aircraft's position. This may use a GPS, a VHF omnidirectional range (VOR) system, or other similar sensor in order to determine and validate the aircraft's exact position. The FMS constantly cross checks among various sensors to determine the aircraft's position with accuracy.

Additionally, the FMS may be used to perform advanced vertical navigation (VNAV) functions. The purpose of VNAV is to predict and optimize the vertical path of the aircraft. The FMS provides guidance that includes control of the pitch axis and of the throttle of the aircraft. In order to accomplish these tasks, the FMS has detailed flight and engine model data of the aircraft. Using this information, the FMS may build a predicted vertical descent path for the aircraft. A correct and accurate implementation of VNAV has significant advantages in fuel savings and on-time efficiency.

The performance function in the FMS computes a Theoretical Descent Path (TDP) which is an optimized path from the cruise flight level to the runway taking into consideration the various constraints such as speed, altitude, aircraft weight, cost index, wind and weather conditions. When a Vertical Automatic Nav mode is selected, the Vert Auto Navigation mode (VNAV/VERT Auto) function in FMS commands the aircraft to follow the TDP using the speed and altitude targets as well as using thrust and pitch control modes. In an ideal situation, the TDP utilized by the aircraft should meet all the constraints and maximize the fuel and overall cost benefits.

However in real flight operations, there are several reasons why aircraft deviate from the FMS constructed TDP. These reasons include: Air Traffic Control (ATC) directing the pilots to fly at specific speeds due to traffic management, weather, etc., which generally takes the aircraft away from the FMS TDP path; specific aircraft performance limitations which make the aircraft unable to stay on the TDP that was developed by the FMS with multiple speed/altitude NAVDB targets; ATC commands early or late descent clearance with respect to the top of descent point as computed by the FMS for the TDP; and atmospheric conditions that vary from the forecast used by FMS for TDP construction. In these scenarios when the aircraft drifts off the FMS constructed TDP, the aircraft will typically end up above or below the TDP profile.

The FMS detects off path flight from TDP and it computes a return with a “capture TDP” profile for the aircraft. This involves a standard set of specific rules to compute an immediate return to the TDP by converging onto the path. The pre-determined set of rules or “hypotheses” built into the TDP construction algorithm, including computation of a rate of descent, idle thrust and/or using airbrakes/speed brakes for speed control, etc. The primary intent is to get the aircraft back to the TDP as soon as possible with the set hypothesis of the FMS adhering to the flight envelopes or constraints in the flight plan.

During flight operations, it is possible for capture TDP attempts to attempt excessive descents rates as part of the return to path logic. These aggressive descent rates are a threat to flight safety and may result in uncomfortable feelings to the passengers, cabin crew, and operating crew. They also lower the margin of recovery space as well as reduce the margin to stay away from any obstacles.

For these reasons, it is common for the flight crew to disengage the Automatic Vertical Path Management Mode in the FMS and control the capture path as desired using selected autopilot modes (Vertical Speed Control Modes, Manual Speed Control Modes, etc.). This results in reduced usability and reliance of the FMS computed trajectory because of a gap between the Vertical Auto commanded flight trajectory and the crew preference to fly the descent in specific situations. In summary, whenever there is a deviation of the aircraft from the TDP, the FMS VNAV deploys a pre-determined set of rules (i.e., hypothesis) to return to the descent path and does not take into account the pilot's preference of how the return to the descent path needs to be controlled.

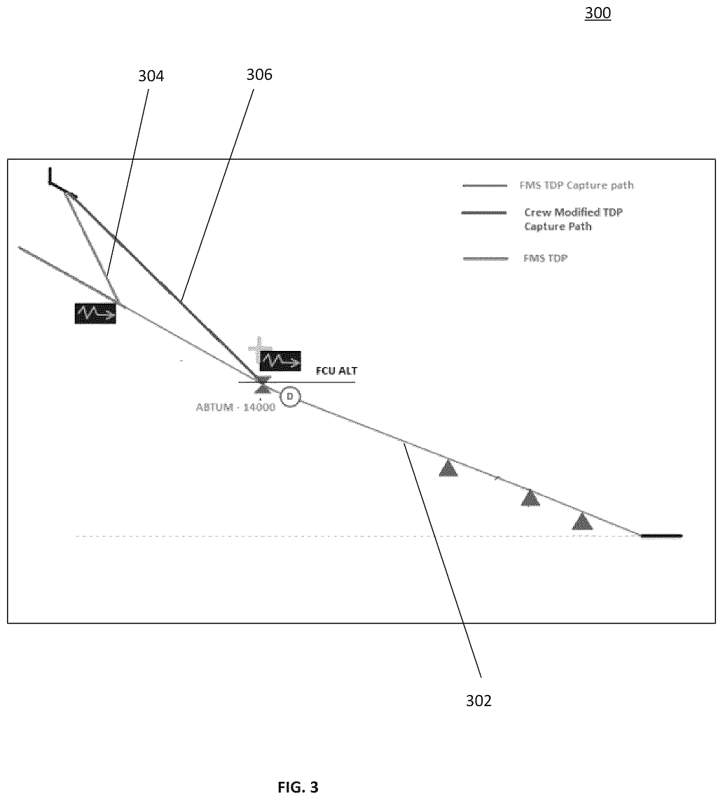

The disclosed embodiments provide a solution to the problem where the FMS computes a reference descent path capture trajectory based on inputs from the crew and controls this modified computed trajectory in VNAV mode. Turning now to FIG. 3, a diagram 300 is shown of a vertical profile view of a captured descent path with modifications in accordance with one embodiment. The FMS generated TDP 302 is shown with the hypothesis generated recovery path 304. However, the hypothesis generated proposed recovery path 304 has a steep descent rate. As a result the aircrew inputs a shallower and slower descent rate to the FMS which generates a modified recovery path 306 to return to the TDP 302.

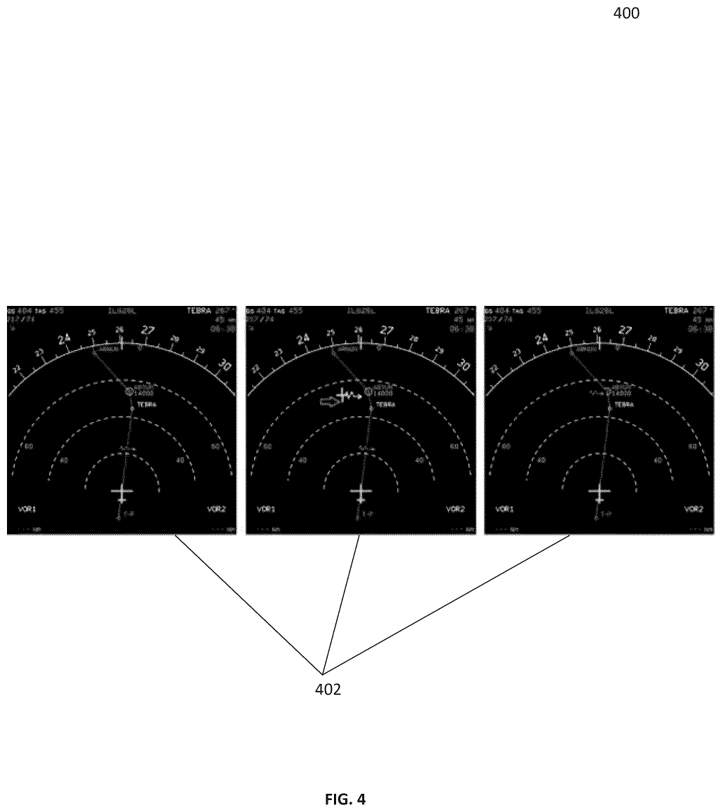

The inputs from the pilot or aircrew may include: descent rate; altitude; time to capture path; and lateral position before which the capture should happen. Turning now to FIG. 4, a captured descent path is shown of a VNAV display view 400 with various modifications in accordance with one embodiment. For each of the crew options, the reference trajectory, default trajectory (FMS computed) and associated symbols (pseudo waypoints), and descent rate is displayed on the VNAV display 402. The crew can fine-tune the options based on the computed trajectory and confirm the same. The VNAV will then control to the newly computed return to path trajectory to capture the descent path. In alternative embodiments, the options for tuning the return to path trajectory after it is computed, the proposed solution provides a mechanism to enter the Max Descent Rate anytime during the flight that will act as a limit to the return to path control. While the examples shown are applied to piloted aircraft, other embodiments can be applied to unmanned aviation vehicles (UAVs) as well.

The disclosed embodiments fill the gaps between the FMS computed standard return trajectory and pilot expected/flown trajectory. This provides a pilot configurable return to path trajectory that can be controlled by FMS in VNAV mode. The embodiments provide a deterministic reference path in VNAV mode for time-based functionalities like required time of arrival (RTA) and estimated Time of Arrival window (ETA min/max) when the aircraft drifts from the reference path.

The disclosed embodiments have the advantages of bringing the crew into the decision-making loop and increasing their confidence in FMS computed path capture. This also increases FMS usability in descent by reducing the manual flight time and also allows the crew to use the FMS optimum descent path while preventing unwanted too-steep path capture maneuvers. As a result, the path predictions and 4D trajectory will be more reliable. This results in higher passenger comfort. The embodiments may also fuel/time benefits by providing smoother RTA operations, which will be then more attractive for the pilots. This can result in significant fuel and time benefits since the FMS may stay in vpath/speed mode and reduce the engine variation. The embodiments also enhance flight safety by avoiding excessive descent rates, too shallow paths, etc.

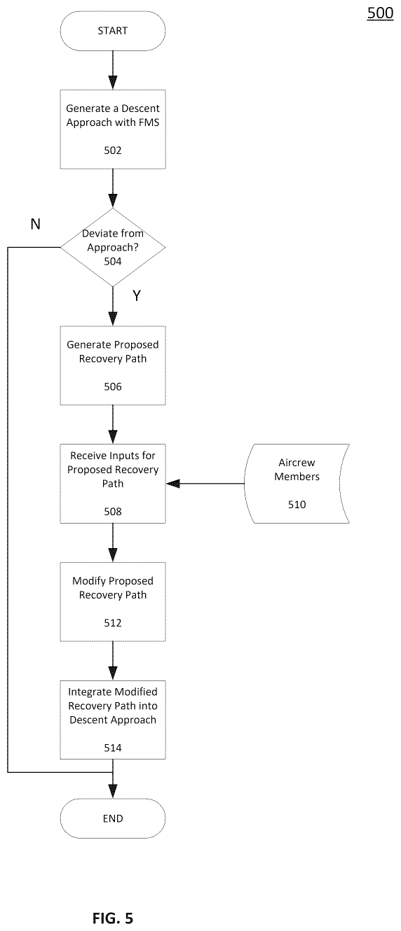

Turning now to FIG. 5, a flowchart 500 is shown of a method for capturing a modified flight descent path for an aircraft in accordance with one embodiment. First, a descent approach path for the aircraft is generated with an FMS 502. A proposed recovery path is generated 506 if the aircraft deviates from the descent approach path during flight operations 504. The proposed recovery path is used by the aircraft to rejoin the original descent approach path. Input regarding the proposed recovery path from aircrew members 510 is received by the FMS 508. The inputs are various flight parameters for the aircraft. The proposed recovery path is modified 512 to comply with the inputs from the aircrew members 510. The modified recovery path is then integrated into the descent approach path 514 by the FMS.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for capturing a modified flight descent path for an aircraft, comprising:
generating a descent approach path for an aircraft with a flight management system (FMS);
deviating from the descent approach path during flight operations;
generating a proposed recovery path for the aircraft with the FMS, where the proposed recovery path rejoins the descent approach path;
receiving inputs for the proposed recovery path for the aircraft with the FMS, where the inputs comprised aircraft flight parameters that are received from aircrew members of the aircraft;
modifying the proposed recovery path to comply with the inputs from the aircrew members; and
integrating the modified recovery path into the descent approach path with the FMS.

2. The method of claim 1, where the aircraft flight parameters comprise a descent rate of the aircraft.

3. The method of claim 2, where the descent rate of the aircraft is set to a predetermined maximum descent rate with the FMS.

4. The method of claim 3, where the predetermined maximum descent rate of the aircraft is set at any point during flight operations of the aircraft.

5. The method of claim 1, where the aircraft flight parameters comprise the altitude of the aircraft.

6. The method of claim 1, where the aircraft flight parameters comprise a time period to rejoin the descent approach path.

7. The method of claim 1, where the aircraft flight parameters comprise a lateral position of the aircraft to rejoin the descent approach path.

8. The method of claim 1, further comprising:
displaying the proposed recovery path for the aircraft on a vertical navigation (VNAV) display to the aircrew.

9. The method of claim 8, further comprising:
displaying the modified recovery path for the aircraft on the VNAV display to the aircrew.

10. The method of claim 1, where the aircraft is an unmanned aerial vehicle (UAV).

11. A system for capturing a modified flight descent path for an aircraft, comprising:
a flight management system (FMS) that,
generates a descent approach path for an aircraft,
generates a proposed recovery path for the aircraft that rejoins the descent approach path, where the proposed recovery path is generated when the aircraft deviates from the descent approach path during flight operations,
receives inputs for the proposed recovery path from aircrew members of the aircraft, where the inputs comprised aircraft flight parameters that are received from aircrew members of the aircraft,
modifies the proposed recovery path to comply with the inputs from the aircrew members, and
integrates the modified recovery path into the descent approach path; and
a vertical navigation (VNAV) display that shows the modified recovery path to the aircrew members.

12. The system of claim 11, where the aircraft flight parameters comprise a descent rate of the aircraft.

13. The system of claim 12, where the descent rate of the aircraft is set to a predetermined maximum descent rate with the FMS.

14. The system of claim 13, where the predetermined maximum descent rate of the aircraft is set at any point during flight operations of the aircraft.

15. The system of claim 11, where the aircraft flight parameters comprise the altitude of the aircraft.

16. The system of claim 11, where the aircraft flight parameters comprise a time period to rejoin the descent approach path.

17. The system of claim 11, where the aircraft flight parameters comprise a lateral position of the aircraft to rejoin the descent approach path.

18. The system of claim 11, where the vertical navigation (VNAV) shows the proposed recovery path to the aircrew members.
